(19) United States
(12) Patent Application Publication
(10) Pub. No.: US 2002/0126384 A1
(43) Pub. Date: Sep. 12, 2002

(54) Spectral filtration of optical radiation

(76) Inventors: Michael P. Petrov, St. Petersburg (RU); Alexander V. Shamrai, St. Petersburg (RU); Victor M. Petrov, St. Petersburg (RU)

Correspondence Address: BROWN, RUDNICK, BERLACK & ISRAELS, LLP., BOX IP, 18TH FLOOR, ONE FINANCIAL CENTER, BOSTON, MA, 02111, US

(21) Appl. No.: 10/044,561

(22) Filed: Jan. 9, 2002

Related U.S. Application Data
(60) Provisional application No. 60/260,555, filed on Jan. 9, 2001.

(51) Int. Cl. G02B 5/18

(52) U.S. Cl. 359/566

(57) ABSTRACT

The present invention provides a new method for spectral filtering of optical radiation wherein the light to be filtered is directed onto two or more spaced apart layers of photosensitive material. A holographic grating is recorded in the layers so that each layer of the photosensitive material contains a portion of the recorded holographic grating. The output optical signal is formed as the result of interference of the light reflected due to the Bragg diffraction from the parts of the diffraction grating recorded in different layers. The reflected light propagates through the spaced apart electrooptical layers sandwiched between the photosensitive layers. The refractive index of the electrooptical layers is varied by the application of the appropriate electrical field to provide the phase difference between the reflected optical signals in order to obtain the desired value of the total output signal resulted from the interference of the reflected light.

This application claims priority from an earlier filed U.S. Provisional patent application Serial No. 60/260,555, filed on Jan. 9, 2001, which application is incorporated by reference herein.

### FIELD OF THE INVENTION

The present invention relates to an optical method and device for spectral filtering of optical radiation. More particularly, the invention relates to tunable optical narrow-band filters.

### BACKGROUND OF THE INVENTION

Photorefractive crystals are considered to be very advantageous for development of narrow-band optical spectral filters which are based on electrically controllable holographic diffraction gratings recorded inside the crystals. Typical examples of such filters, employing photorefractive crystals, were described in the paper <<Volume holographic narrow-band optical filter”, Optics Letters, Vol.18, No.6, pp.459-461 (1993); U.S. Pat. No. 5,684,611 “Photorefractive systems and methods”; and is U.S. Pat. No. 5,796,096 “Fabrication and applications of long-lifetime, holographic gratings in photorefractive materials”. In all the mentioned filters a holographic grating is used to select a portion of incoming light that satisfies the so-called Bragg condition. The holographic grating has the form of periodic variation of the crystal refractive index with respect to its average value. The Bragg condition determines the central wavelength λ^{r} of the spectral range within which the incoming light is reflected by the grating. λ^{r} satisfies the Bragg condition:

λ^{r}=2nΛ, (1)

where n is the average index of refraction of the crystal, and Λ is the period of the diffraction grating. Since modulation of the grating refractive index in a holographic diffraction grating is usually small, the spectral selectivity of the filter can be described as follows:

$$\frac{δ {λ}^{r}}{{λ}^{r}} = \frac{Λ}{T} ,$$

where δλ^{r} is the filter band, or, in other words, the portion of the spectrum within which the light is reflected by the grating; and T is the diffraction grating length. In case of a diffraction grating with large modulation of the refractive index, the spectral width depends on the magnitude of the grating modulation and not on the grating length. The light with the wavelengths differing from δλ^{r} passes through the grating without being reflected.

In order to adjust the filter band, it is possible to change the magnitude of λ^{r} by application of an external electric field E to the crystal. Such approach is described in “Tuning of photorefractive interference in LiNbO₃”, J. Phys. D: Appl. Phys., 27, 1628-1632 (1994).

If we consider a particular polarization of the light propagating in a photorefractive crystal, the variation of the average index of refraction n induced by electric field E is determined by the linear electrooptical effect (the Pockels effect) and can be described as follows:

$$Δ n = \frac{1}{2} {n}_{0}^{3} r E , \qquad ( 2 )$$

where Δn is the variation of the refractive index; n₀ is the average refractive index of the crystal for E=0; and r is the effective electrooptical coefficient that depends on the light polarization and the direction of the electric field with respect to the principal crystallographic axis.

By varying the field strength E, the refractive index can be changed to provide tuning of the filter and select a particular wavelength λ^{r} of the incoming light to be filtered out according to Eq.(1).

In order to increase the tuning range of the filter, a crystal with high electrooptical coefficient has to be used. Unfortunately, lithium niobate (LiNbO₃), which is typically used for recording and fixing of holographic gratings, has a relatively low electrooptical coefficient.

There are several types of photorefractive crystals that exhibit high electrooptical coefficients, for example, barium titanate (BaTiO₃), potassium niobate (KNbO₃), and barium-strontium niobate (SBN). However, they do not allow obtaining high diffraction efficiency of the holographic grating which is recorded and fixed in the crystal, and, therefore, are not suitable for fabrication of filters with relevant characteristics.

U.S. Pat. No. 5,640,256 “Dynamic multiple wavelength filter using a stratified volume holographic optical element” describes an optical spectral filter fabricated in the form of a multilayered structure consisting of layers of a photosensitive electrooptic material interposed by optically transparent electrodes, in which an electric field can be created separately in each layer. In each layer of the photosensitive electrooptical material, a holographic diffraction grating is recorded. The period of each grating is determined by the Bragg condition for the wavelength to be selected by this grating from the input light. The described filter can simultaneously filter out from the incoming light from a number of wavelengths reflected by individual gratings.

Since a paraelectric crystal is used in U.S. Pat. No. 5,640,256 for recording of the diffraction gratings, the diffraction efficiency of the gratings is low when the external electric field is switched off and, hence, the reflected optical signal has small amplitudes. Selection of specific spectral component is initiated by increasing the diffraction efficiency of the corresponding grating by applying an electric field to the corresponding layer. This filter can efficiently operate only at the temperatures in the vicinity of the ferroelectric-paraelectric phase transition point where electrooptical properties of the material are the most pronounced.

The major disadvantage of the filter described in U.S. Pat. No. 5,640,256 is related to its failure to simultaneously achieve high diffraction efficiency and high spectral selectivity of the filter. In fact, in order to do this the recorded grating has to have sufficient length, typically of the order of one centimeter. If such a multilayered filter were fabricated for operation of, say, ten narrow-band spectral components, its length would amount to 10 cm, which, in turn, would results in strong absorption of the light in the filter. This means that described filter arrangement cannot be used for development of a filter with a combination of large number of operated channels, low insertion loss and high spectral selectivity cannot be produced.

### SUMMARY OF THE INVENTION

The present invention provides a multichannel optical spectral filter with high spectral selectivity that can be tuned within a wide range of wavelengths.

According to the present invention, a tunable optical spectral filter, based on the Bragg diffraction of optical radiation from a reflective holographic grating, is fabricated in the form of a mutilayered structure consisting of two or more layers of a photosensitive material, such as photorefractive crystal, photopolymer, chalcogenide glass, and others, separated by the layers of an electrooptic material to which an electric field can be applied. In contrast to U.S. Pat. No. 5,640,256 mentioned above, where only one grating is recorded in each layer, in present invention each photosensitive layer contains a portion of every recorded holographic diffraction grating recorded in the filter. The length of each grating is equal to the length of the filter, and each grating is a sum of its parts simultaneously recorded in all the photosensitive layers. The periods of the recorded gratings correspond to the Bragg condition for the wavelengths assigned to be filtered out of the input light. To record a grating, two counterpropagating coherent light beams passing through the layered structure are used. The grating with a predetermined period is recorded for each particular wavelength of recording light and particular magnitude of the electric field applied to the multilayered structure. A set of holographic gratings can be recorded by using a corresponding set of predetermined light wavelengths and electric field strengths. As a result, a filter structure is formed where each holographic grating is recorded in the way that the phase matching condition (continuity of the phase of the portions of the grating located in adjacent layers) is satisfied along the entire multilayered structure for the particular recording conditions (magnitude of the applied electric field strengths in the electrooptic layers, and the wavelength of the recording light). Hence, if a specified electric field is applied to the filter during its operation, the grating selects a narrow spectral range of the incoming light with the desired wavelengths according to the Bragg condition. The light reflected on other gratings operating for different wavelengths is subjected to a destructive interference because of the phase discontinuity, which minimizes the reflected signal for those wavelengths.

The present invention provides a new method for spectral filtering of optical radiation wherein the light to be filtered is directed onto two or more spaced apart layers of photosensitive material. A holographic grating is recorded in the layers so that each layer of the photosensitive material contains a portion of the recorded holographic grating. The output optical signal is formed as the result of interference of the light reflected due to the Bragg diffraction from the parts of the diffraction grating recorded in different layers. The reflected light propagates through the spaced apart electrooptical layers sandwiched between the photosensitive layers. The refractive index of the electrooptical layers is varied by the application of the appropriate electrical field to provide the phase difference between the reflected optical signals in order to obtain the desired value of the total output signal resulted from the interference of the reflected light.

In contrast to the known filters, in the present invention diffraction of the filtered light and electrically controlled phase matching take place in separate layers. Holographic gratings are recorded in the photosensitive material which may have poor electrooptical properties, and therefore there is a possibility to select the materials with the best photosensitive characteristics to record diffraction gratings in the desired wavelength range. Accordingly, the materials with high electrooptical characteristics can be selected for the electrooptical layers. Overall the described separation allows one to fabricate filters for different wavelength ranges and with a wider tuning range.

Simultaneously, a high spectral selectivity is achieved because the effective length of the grating, reflecting the filtered light spreads across the total length of the multilayered structure where the grating is recorded. The total length of the filter is determined by the required grating length and does not increase proportionally to the number of filtered wavelength, as it usually is the case in other filter designs, for example, in the filter described in U.S. Pat. No. 5,640,256.

### BRIEF DESCRIPTION OF THE DRAWINGS

The present invention is described with reference to the drawings of the following figures:

FIG. 1 is a schematic illustration of the structure of the filter of the present invention;

FIG. 2 is a schematic illustration of recording holographic gratings in the photosensitive layers;

FIG. 3(a, b, c) are schematic illustrations of holographic gratings in the filter;

FIG. 4 is a schematic illustration of the operation of the filter.

FIG. 5 is a schematic illustration of an embodiment of the invention.

### DETAILED DESCRIPTION OF PREFERRED EMBODIMENTS

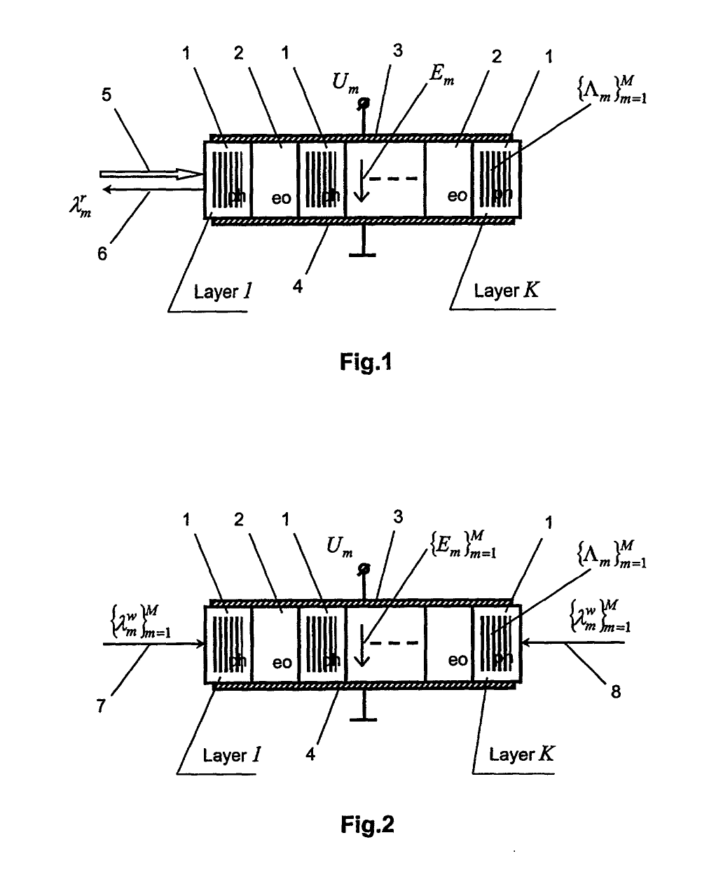

The filter of the present invention shown in FIG. 1 comprises layers 1 of a photosensitive material (ph) used to record volume phase holographic gratings and layers 2 of an electrooptic material (eo) whose index of refraction can vary depending on the strength of the applied external electric field. All the layers 1 and 2 form a multilayered structure with an optical contact between the layers, the layers 2 of the electrooptic material being interposed between the layers 1 of the photosensitive material, the total number of the photosensitive material layers being K. The total amount of gratings recorded in the filter is M, M≦K. The m-th holographic grating has period Λₘ, where m is the number of the grating. In each layer 1 of the photosensitive material the parts of all the gratings are recorded. The m-th holographic grating is recorded in the presence of a specified electric field Eₘ, which is produced in the layers 2 of the electrooptic material with the help of electrodes 3 and 4. The portions of the grating with the same number m recorded in different layers 1 of the photosensitive material turn out to be phase matched with each other. The condition of grating phase matching means that if a polychromatic light beam 5 is incident on the filter, the light beams reflected from these parts of the grating in a narrow wavelength range corresponding to the Bragg condition will have a zero (or multiple to 2π) relative phase shift. As a result, the light beams reflected from the phase matched parts of the grating form an output signal 6 with the central wavelength λₘ^{r}.

Such a filter operation is provided by selecting the proper combinations of the recording light wavelengths and strengths of the electric field produced within the layers 2 of the electrooptic material during holographic grating recording, and also by using a proper sequence of recordings of holographic gratings in the layers 1 of the photosensitive material.

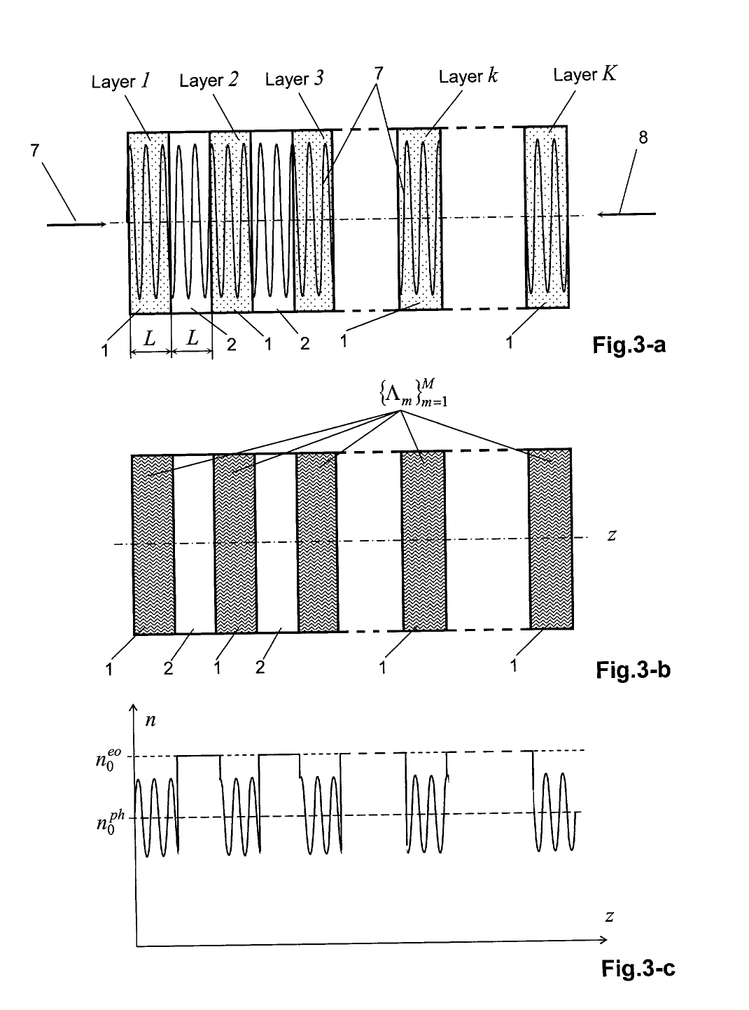

FIG. 2 shows one of the possible arrangements for recording holographic gratings in the layers 1 of the photosensitive material. In this particular geometry, gratings are recorded by directing two counterpropagating recording light beams 7 and 8 onto end faces of the multilayered structure. In this case, an interference pattern 9 is formed inside the multilayered structure consisting of K layers 1 of the photosensitive material (see FIG. 3a). This interference pattern is recorded in the layers 1 of the photosensitive material (FIG. 3b) as a phase holographic grating (see FIG. 3c) which represents local variations in the refractive index n(z), where the z coordinate is along the multilayered filter structure. The refractive index distribution nₖ in the k-th layer 1 of the photosensitive material is given by:

$${n}_{k} = {n}_{0}^{ph} + {n}_{G} sin ( \frac{2 π}{Λ} z + {ϕ}_{k} ) , \qquad ( 3 )$$

where n₀^{ph} is the average index of refraction of the layer 1 of the photosensitive material; n_{G} is the grating amplitude; Λ is the grating period; and φₖ is the phase shift of the grating in the k-th layer 1 of the photosensitive material.

The diffraction grating period Λ is determined by the wavelength λ^{w} of the recording beams 7 and 8 in vacuum and the average refractive index n₀^{ph} of the layer 1 of the photosensitive material and is given by:

$$Λ = \frac{{λ}^{w}}{2 {n}_{0}^{ph}} . \qquad ( 4 )$$

In view of the fact that in the general case the layers 1 of the photosensitive material and the layers 2 of the electrooptic material exhibit different average indexes of refraction n₀^{ph} and n₀^{eo}, respectively, the phase shift of the grating part recorded in the k-th layer 1 of the photosensitive material relative to z=0 is defined as:

$${ϕ}_{k} = 2 ( k - 1 ) L \frac{2 π}{{λ}^{w}} ( {n}_{0}^{eo} - {n}_{0}^{ph} ) , \qquad ( 5 )$$

where L is the thickness of the layer 2 of the electrooptic material, and it is assumed that all the layers 2 have equal thicknesses.

In the case of successive recordings of the holographic gratings in the layers 1 of the photosensitive material, the wavelength of the recording beams 7 and 8 varies within the range from λ₁^{w} to λ_{M}^{w}. The step of variation in the wavelength Δλ^{w} being much smaller than the wavelengths of the recording beams 7 and 8, i.e.,

$$\frac{Δ {λ}^{w}}{{λ}_{m}^{w}} << 1. \qquad ( 6 )$$

During recording, the strength Eₘ of the electric field in the layers 2 of the electrooptic material is also changed, the step of variation being ΔE. In this case the index of refraction of the layers 2 varies by:

$$Δ {n}_{m}^{eo} ( {E}_{m} ) = - \frac{1}{2} {( {n}_{0}^{eo} )}^{3} rm Δ E , \qquad ( 7 )$$

where r is the electrooptic coefficient of the material from which the layers 2 are made, and m is the number of the recorded grating.

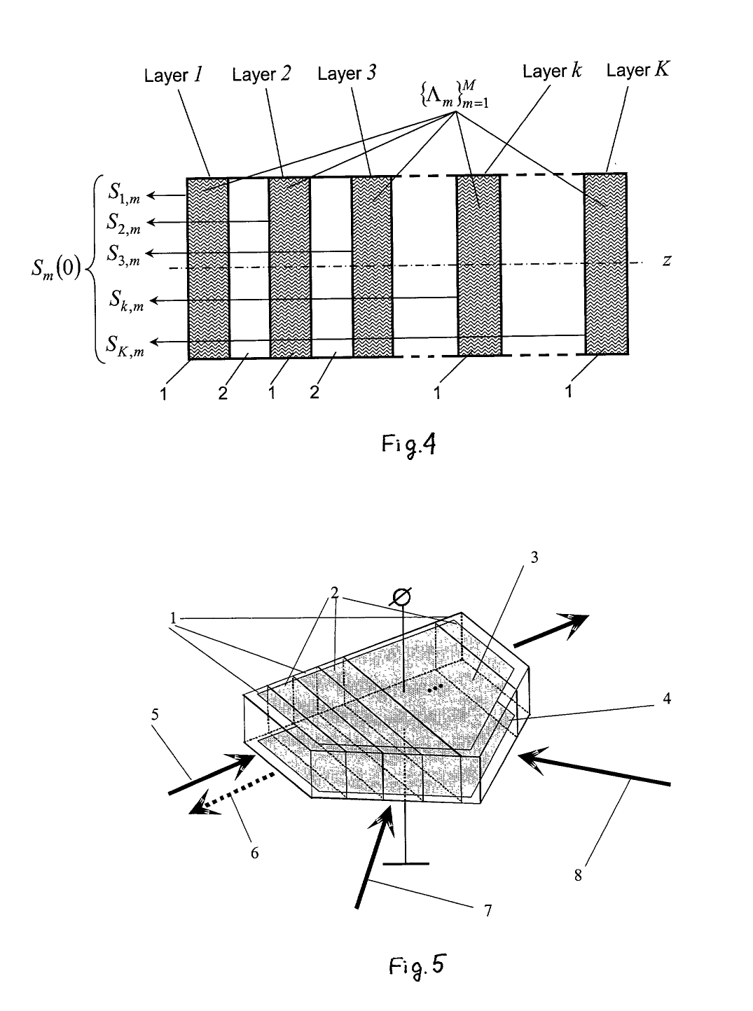

In order to determine Δλ^{w} and ΔE, we consider diffraction of the beam of radiation 5 to be filtered from the holographic gratings recorded in the layers 1 of the photosensitive material (see FIG. 4).

Reflection of a light wave from a holographic grating was considered in the scope of the theory of coupled waves described by H. W. Kogelnik in Bell. Sys. Tech. J., vol. 48, p. 2909 (1969). The amplitude of the light wave reflected from the portion of the m-th grating recorded in the k-th layer 1 of the photosensitive material in the kinematic approximation (i.e., in the case of a low diffraction efficiency of the grating when a decrease in the amplitude of radiation incident on this grating can be ignored) is given by:

$${S}_{k , m} = - i {χ}_{m} R ( 0 ) L sin \frac{{ξ}_{m}}{{ξ}_{m}} , \qquad ( 8 )$$

where χₘ is the coupling constant, which depends on the grating amplitude and which is assumed, for simplicity, to be the same in all the layers 1 of the photosensitive material

$${χ}_{m} = \frac{π {n}_{G}}{{λ}_{m}^{w}} ;$$

R(0) is the amplitude of the radiation incident on the grating; L is the thickness of the layer 1 of the photosensitive material (to simplify calculations, thicknesses of the layer 1 of the photosensitive material and of the layer 2 of the electrooptic material were assumed to be equal); and ξₘ is the parameter of spectral detuning which is proportional to the difference between the wavelength of the optical radiation satisfying the Bragg condition and the actual wavelength of the beam reflected from the grating.

The amplitude of the reflected total signal Sₘ (0) with the central wavelength λₘ^{r} defined as the filtered signal corresponding to the external electric field Eₘ=E₁+mΔE applied to the structure is found by summing up the light beams reflected from all the parts of all the gratings recorded in all the layers 1 of the photosensitive material with corresponding phase multipliers:

$${S}_{m} ( 0 ) = - i {\sum }_{l = 1}^{M} {χ}_{l} R ( 0 ) L \frac{sin {ξ}_{l}}{{ξ}_{l}} {\sum }_{k = 1}^{K} exp \{ ⅈ2 \frac{2 π}{{λ}_{1}^{w}} L ( k - 1 ) \cdot \\ ( l - m ) [ Δ {n}^{eo} ( Δ E ) - \frac{Δ {λ}^{w}}{{λ}_{1}^{w}} ( {n}_{0}^{ph} + {n}_{0}^{eo} ) ] \} , \qquad ( 9 )$$

where

$$Δ {n}^{eo} ( Δ E ) = - 1 / 2 \cdot {( {n}_{0}^{eo} )}^{3} r Δ E$$

is the steps of variation in the refractive index.

FIG. 4 shows an example of formation of signal Sₘ (0) in the form of superposition of light beams S_{1, m}, S_{2, m}, . . . , S_{K, m} reflected from all the parts of the m-th grating. To simplify the picture, these light beams, which are actually reflected from the entire cross sectional area of the filter, are shown by narrow arrows in FIG. 4.

Eq. (9) was obtained for a low diffraction efficiency when multiple re-reflection of the light beam can be disregarded. Also disregarded are the Fresnel reflection at the interfaces between layers 1 and 2 and the terms of the second order of smallness which are proportional

$$\frac{Δ {n}^{eo} ( Δ E ) Δ {λ}^{w}}{{λ}_{1}^{w}} and {( \frac{Δ {λ}^{w}}{{λ}_{1}^{w}} )}^{2} .$$

In Eq. (9), the sum over k is the sum of geometric progression with denominator q, i.e.,

$${\sum }_{k = 1}^{K} {q}^{k - 1} = \frac{{q}^{k} - 1}{q - 1} .$$

In this case

$$q = exp \{ ⅈ [ 2 \frac{2 π}{{λ}_{1}^{w}} L \cdot ( l - m ) [ Δ {n}^{eo} ( Δ E ) - \frac{Δ {λ}^{w}}{{λ}_{1}^{w}} ( {n}_{0}^{ph} + {n}_{0}^{eo} ) ] ] \} . \qquad ( 10 )$$

Taking into account Eq. (10), Eq. (9) acquires the form:

$$S ( 0 ) = - i {\sum }_{l = 1}^{M} {χ}_{l} R ( 0 ) L \frac{sin {ξ}_{l}}{{ξ}_{l}} \frac{\begin{matrix}exp \{ ⅈ 2 \frac{2 π}{{λ}_{1}^{w}} LK ( l - m ) [ Δ {n}^{eo} ( Δ E ) - \\ \frac{{Δλ}^{w}}{{λ}_{1}^{w}} ( {n}_{0}^{ph} + {n}_{0}^{eo} ) ] \} - 1\end{matrix}}{\begin{matrix}exp \{ ⅈ2 \frac{2 π}{{λ}_{1}^{w}} L ( l - m ) [ Δ {n}^{eo} ( Δ E ) - \\ \frac{{Δλ}^{w}}{{λ}_{1}^{w}} ( {n}_{0}^{ph} + {n}_{0}^{eo} ) ] \} - 1\end{matrix}} . \qquad ( 11 )$$

In Eq. (11), the dependence on Δλ^{w} and ΔE is present only in the ratio

$$A = \frac{\begin{matrix}exp \{ ⅈ 2 \frac{2 π}{{λ}_{1}^{w}} LK ( l - m ) [ Δ {n}^{eo} ( Δ E ) - \\ \frac{Δ {λ}^{w}}{{λ}_{1}^{w}} ( {n}_{0}^{ph} + {n}_{0}^{eo} ) ] \} - 1\end{matrix}}{\begin{matrix}exp \{ ⅈ2 \frac{2 π}{{λ}_{1}^{w}} L ( l - m ) [ Δ {n}^{eo} ( Δ E ) - \\ \frac{Δ {λ}^{w}}{{λ}_{1}^{w}} ( {n}_{0}^{ph} + {n}_{0}^{eo} ) ] \} - 1\end{matrix}} . \qquad ( 12 )$$

The next step involves determining Δλ^{w} and ΔE at which Eq.(12) reaches the maximum value A=Aₘₐₓ for a particular holographic grating recorded at λₘ^{w} and the minimum value A=0 for all other gratings recorded in the structure. As a result, wavelength λₘ^{w} of the recording beams and strength Eₘ of the electric field at which the m-th holographic grating is recorded and which provide for the phase matching of the portions of only that grating during the filtering under Eₘ can be found.

Analysis shows that Eq. (12) reaches the maximum when the denominator approaches zero; this condition is satisfied automatically for l=m.

At the points where the numerator of Eq. (12) goes to zero, and the denominator is a nonzero, Eq. (12) is zero, which is equivalent to:

$$Δ {n}^{eo} ( Δ E ) - \frac{Δ {λ}^{w}}{{λ}^{w}} ( {n}_{0}^{ph} + {n}_{0}^{eo} ) = \frac{j {λ}^{w}}{2 LK} \qquad ( 13 )$$

where j is the nonzero integer not multiple to K.

Eq. (13) describes the relationship between the steps of variation in the refractive index of the electrooptic material and the step of variation in the wavelength of the recording light at which the total reflected light beam (from all the layers 1 of the photosensitive material) for the grating “l” (at l≠m ) has a zero amplitude under Eₘ.

From Eq. (13) one can find the steps of variation in the refractive index Δn^{eo} (ΔE) of the layers 2 of the electrooptic material and the steps of variation in the recording light wavelengths Δλ^{w} which ensure recording of each next holographic grating under the condition that the reflected signal from all the previously recorded gratings is zero. To make this more understandable, consider recording of two successive gratings. The first grating is recorded by the recording light at λ₁^{w} under electric field E₁. The next step is to change the electric field applied to the structure E₂=E₁+ΔE. The step of variation in the electric field ΔE provides the change of the refractive index Δn^{eo} (ΔE) at which the amplitude of the light reflected from the first grating is zero. In order to find this change in the refractive index, the second term on the left-hand side of Eq.(13) is presumed to be zero.

$$Δ {n}^{eo} ( Δ E ) = \frac{{λ}^{w}}{2 LK} ; \qquad ( 14 )$$

In Eq.(14) it is assumed that j=1, since a low switching electric field is preferable. Then a second grating under E₂ is recorded. The recording wavelength can be obtained from Eq.(13) by substituting Eq.(14) into it.

$$Δ {λ}^{w} = - ( j - 1 ) \frac{{( {λ}^{w} )}^{2}}{2 LK ( {n}_{0}^{ph} + {n}_{0}^{eo} )} . \qquad ( 15 )$$

Thus by using the magnitudes of Δλ^{w} and ΔE , it is possible to successively record M holographic gratings in layers 1 of the photosensitive material, thereby forming an optical spectral filter with the properties indicated above, wherein at a particular electric field strength only portions of a particular grating recorded in different layers 1 of the photosensitive material will be matched. The resulting light beam formed by the individual light beams reflected from those portions of the grating in a narrow wavelength range corresponding to the Bragg condition is the output signal (filtered signal) from the filter of this invention. In this case the total beam formed by the light beams reflected from other gratings will be zero. Note that the step of variation in the light wavelength Δλ^{w} and external electric field ΔE can be increased by j times, and j should not be a multiple of K.

The optical spectral filter of this invention can be used for multiplexing optical signals, in particular in DWDM systems, where signals are transmitted through channels with a discrete set of wavelengths. Controlling such signals by the filter is performed by varying the electric field strength in the electrooptical layers.

If two or more holographic gratings, rather than one grating, are recorded in the photosensitive layers at the same magnitude of the electric field applied to the multilayered structure, all these gratings will be phase matched during the filtering process, provided that the electric field applied to the filter is the same as that used for recording. Thus the filter will select the light beam in two or more narrow spectral ranges simultaneously. Therefore, depending on the purpose, both one-channel and multichannel tunable optical spectral filters can be fabricated.

In the embodiment of the present invention described above, electric field of the same strength was applied to all the electrooptical layers. In this case the range of variation in the applied electric field is proportional to the number of wavelengths for which the filter is fabricated. To reduce the absolute values of the electric field used in the filter, electric fields with different strengths can be applied to individual electrooptical layers instead of the whole filter. If such a reduction in absolute values of the electric field can be achieved, the number of filtered wavelengths and the speed of tuning the filter can be increased.

Layers 2 of the present invention can be made not only of crystals, but also of liquid-crystal materials. In this case the absolute value of the electric field produced in the layers 2 can be substantially reduced.

Also, layers 2 can be made of materials with magnetrooptical properties. In this case, the tuning is performed by applying magnetic field to layers 2.

Another embodiment of the present invention is illustrated in FIG. 5. As seen in FIG. 5, the multilayered structure of the filter is implemented in the form of a prism. In the prism geometry the two recording light beams 7 and 8 are not counterpropagating. The recording beams 7 and 8 propagate at an angle relative to each other and intersect inside the prism, forming a diffraction grating the photosensitive layers 1 of the filter. In such a filter, it is possible to use the recording beams with a wavelength smaller than the wavelength of the incoming polychromatic beam. The electric field is applied by means of electrodes 3 and 4 to the whole filter, as seen in FIG. 5. The following relationship between the above-desfribed parameters for the process of recording the gratings needs to be fulfilled:

$$Λ = \frac{{λ}^{w}}{2 {n}_{0}^{ph} sin θ} .$$

In any embodiment of this invention, it is desirable that Rayleigh reflection at the interface between photosensitive and electrooptic materials arising in the case of substantially differing refractive indexes of these materials be suppressed. Any known method of deposition of light-reflecting coatings can be used to achieve that goal.

What is claimed is:

1. A method of filtering optical radiation comprising:
providing a plurality of spaced apart photosensitive layers having a diffraction grating recorded in each photosensitive layer, the diffraction grating having a grating period being the same in each photosensitive layer;
providing a plurality of spaced apart layers having a varying refractive index, wherein each layer having the varying refractive index is disposed between two photosensitive layers;
passing a polychromatic beam through the plurality of photosensitive layers and layers with the varying refractive index and causing the beam to diffract from the diffraction grating forming an output signal, the polychromatic beam comprising a plurality of spectral components; and
varying the refractive index of the layers with the varying refractive index in such a way that the phase differences of the spectral components is minimized or maximized, therefore, minimizing or maximizing the output signal.

2. The method of claim 1, wherein the plurality of layers having a varying refractive index is made of electrooptical material.

3. The method of claim 2, wherein varying the refractive index comprises applying a voltage to the electrooptical material.

4. A method of providing an optical tunable filter comprising:
providing two or more layers of elecrooptical material and layers of photosensitive materials sandwiched between the layers of photorefractive materials,
providing counterpropagating recording beams forming a plurality of the diffraction gratings in the layers of photosensitive material; and
recording the plurality of the diffraction gratings at different voltages applied to the layers of electrooptical material and at different wavelengths of the recording beams.

5. The method of claim 4, where in the number of the diffraction gratings in the is no greater than the number of the layers of photorefractive material.

6. The method of claim 5, wherein a wavelength of the recording beams is selected according to the condition:
$$Δ {λ}^{w} = - ( j - 1 ) \frac{{( {λ}^{w} )}^{2}}{2 LK ( {n}_{0}^{ph} + {n}_{0}^{eo} )} ,$$
and wherein a voltage applied to the layers of electrooptical material is selected according to the condition:
$$Δ {n}^{eo} = ( Δ E ) = \frac{{λ}^{w}}{2 LK} .$$

7. The method of claim 4, wherein the voltage is applied by means of a single pair of electrodes.

8. A tunable optical filter comprising:
a multilayered structure comprising at least two photosensitive layers of and one or more electrooptical layers, each electrooptical layer being sandwiched between photosensitive layers; and
a plurality of diffraction gratings recorded in the photosensitive layers and having a grating period, the number of the diffraction gratings being the same in each photosensitive layer;
wherein the plurality of the diffraction gratings is recorded in the photosensitive layers in such a way that for a predetermined voltage applied to the electrooptical layers only the gratings of the same grating period will meet a phase matching condition.

9. The filter of claim 8, wherein the number of the diffraction gratings in each photosensitive layer is no greater then the number of photosensiting layer in the multilayered structure.

10. The filter of claim 8, wherein the voltage is applied to the photosensitive and electrooptical layers simultaneously by a pair of electrodes.
